(19) United States
(12) Patent Application Publication
(10) Pub. No.: US 2023/0377776 A1
(43) Pub. Date: Nov. 23, 2023

(54) DEVICE FOR BUNDLING A NUMBER OF CABLES

(71) Applicant: Weidmüller Interface GmbH & Co. KG, Detmold (DE)

(72) Inventors: Falk LEIMKÜHLER, Schlangen (DE); Matthias NOLDUS, Detmold (DE); Lars BRAKEMEIER, Dörentrup (DE); Stefan MÜLLER, Borgenteich (DE); Christian DÜLME, Paderborn (DE); Bruno NEUMANN, Detmold (DE); Fabrice LOGES, Höxter (DE); Roman Andre MITTELGÖKER, Detmold (DE)

(21) Appl. No.: 18/310,206

(22) Filed: May 1, 2023

(30) Foreign Application Priority Data
May 23, 2022 (DE) 102022112929.2

(51) Int. Cl. H01B 13/012

(52) U.S. Cl. CPC H01B 13/01281; H01B 13/01209

(57) ABSTRACT

A device for bundling a number of cables includes at least one rotatable feeding wheel which has on the periphery a number of notches for receiving in each case at least one cable, a pressure roller which can be pushed against an abutment in a spring-loaded manner and two spaced-apart roller receptacles each for mounting an adhesive tape roll with an unwindable adhesive tape, wherein the adhesive tapes are guided with their adhesive surfaces facing one another between the abutment and the pressure roller.

This application claims priority of DE 10 2022 112 929.2 filed on May 23, 2022, the entire content of which is incorporated herein by reference.

### BACKGROUND OF THE INVENTION

The invention relates to a device for bundling a number of cables, which connect electrical appliances to one another. By way of example, mention should be made of the fitting out of a switch cabinet, which is manufactured in a factory and which is connected in function to further equipment which corresponds to it electrically.

Depending on need, use is made of different cables which are each equipped with an appropriate reference, such as an information label, for the purposes of identification.

However, fitting out a switch cabinet with various cables can be problematic in that the individual cables have to be mounted separately, which requires a relatively high labor outlay.

In the case of a large number of cables which are intended to be attached to the same equipment, these cables are assembled into a bundle by cable connectors. This is also complex and cost-intensive and is contrary to a constant demand for optimization of costs.

### BRIEF DESCRIPTION OF THE PRIOR ART

DE 10 2018 131 439 A1 and DE 10 2018 131 444 A1, which each address a modular cable-processing center, disclose a bundling unit, but lack structural details to enable simplified bundling of a number of cables.

There is known from U.S. Pat. No. 5,878,489 a method and apparatus for manufacturing a flat cable for a cable tree in which a plurality of individual cables are fixed by a reinforcing strip which is glued to the cables via resin.

The use of this flat cable is naturally restricted since the individual cables are relatively close to one another, which means that this flat cable can only be used in situations in which the terminals assigned to each individual cable are also appropriately close together.

There is thus a need for a device of the generic type such that simple bundling of a number of cables is possible and the handling of the bundle becomes simpler.

### SUMMARY OF THE INVENTION

An objective of the present invention is to provide a device for bundling a number of cables, including at least one rotatable feeding wheel having a plurality of notches arranged on its periphery for receiving at least one cable, a spring-loaded pressure roller configured for contact with an abutment, and two spaced-apart roll receptacles each for mounting a roll of unwindable adhesive tape. Adhesive tape from each roll is guided between the abutment and the pressure roller such that an adhesive surface of each adhesive tape faces an adhesive surface of the other.

Firstly, the novel device is distinguished by its simple design, through which the device is able to be manufactured cost-effectively. Moreover, the simple design leads to a lower susceptibility of disruption, i.e. to a long service life and easy operability.

It is possible to employ the device in sole operation, but also as a functional part in the cable-processing center.

The operation of the device, above all the insertion of the individual cables into the notches is performed manually, just like the driving of the roll of adhesive tape by simply rotating the feeding wheel by means of the cable inserted into the notch, as a result of which the roll of adhesive tape is carried along, so to speak.

In a most simple embodiment, only one rotatable feeding wheel is provided, with the directly adjacent abutment which, as in accordance with a further idea of the invention, is configured as a roller and is arranged in a manner rotating identically to the feeding wheel, directly adjacent to it.

However, there are preferably two feeding wheels provided which are rotationally fixed relative to one another and of which the notches are congruent in the axial direction, with the abutment being arranged between these two feeding wheels.

In this case, the abutment and the pressure roller are arranged in a plane which is vertical in the functional position. The thickness of the pressure roller, like that of the abutment, if this is arranged as a roller between the two feeding wheels, corresponds to the clear distance of the two feeding wheels relative to one another, as a result of which a lateral guiding of the adhesive tapes is achieved.

The radius of the abutment configured as a roller corresponds to the radius of the feeding wheel up to the base of the notch. In other words, the abutment aligns with the notch at its deepest location.

The spacing of the individual notches relative to one another determines the spacing of the cables in a bundled position, with the at least one feeding wheel being able to be exchanged in order to thus vary the spacings between the bundled cables if necessary. Furthermore, it is possible to provide a different quantity of notches in a different configuration on the feeding wheels.

Moreover, the notches are configured in a wedge shape and are dimensioned in the circumferential width of the base such that, in any case, the inserted cable bears on top.

Besides the stated manual driving of the rotatable components, a motor drive is also possible, with this being preferred above all in the case of automated bundling.

To bring into contact the two adhesive tapes which are guided with their adhesive surfaces facing one another on the one hand, and to drive over the cable which is to be fixed, the pressure roller is resiliently mounted such that it can automatically perform an appropriate stroke.

The quantity of cables to be bundled is freely selectable and depends only on the requirement. Accordingly, one or more cables can be inserted into a notch in the feeding wheel.

Use is preferably made of adhesive tapes which can easily be torn off in sections by hand. Conversely, it is also possible for a cutting device to be provided for the separation.

To spring-load the pressure roller, a force store is provided, preferably in the form of a pressure spring, such as a coil spring.

Moreover, the device has a supporting frame onto which the functional parts, i.e. the feeding wheel, the abutment, the pressure roller and the roller receptacles, are affixed. A structural unit is created which can be premounted in a factory and which can be employed as a compact unit either as a module of a cable-processing center or in a freestanding manner at the location of the manufacture of the cable bundle.

### BRIEF DESCRIPTION OF THE DRAWINGS

The invention will be explained in greater detail below using embodiments with the aid of the accompanying figures in which:

FIG. 1 is a perspective view of a device according to the invention;

FIG. 2 is a side view of the device of FIG. 1;

FIG. 3 is a plan view of the device of FIG. 1;

FIGS. 4a-4d are further embodiments of the device according to the invention;

FIG. 5 is a front view of a portion of a device according to the invention;

FIG. 6 is a side view of the device shown in FIG. 5;

FIG. 7 is a perspective view of the feeding wheels of a device according to the invention; and

FIG. 8 is a perspective view of a device according to the invention on a modular cable-processing center.

### DETAILED DESCRIPTION

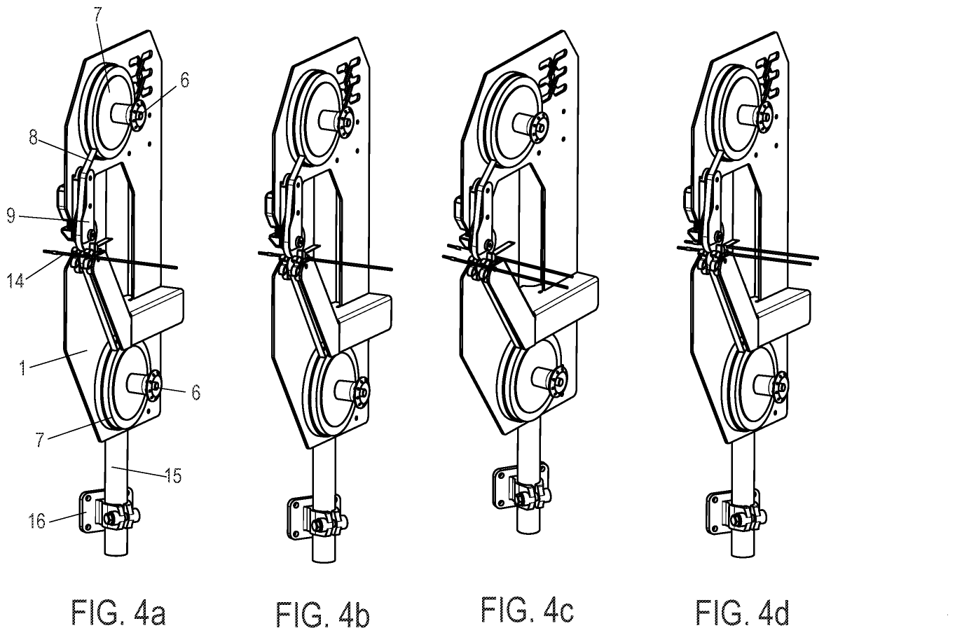

The figures depict a device for bundling a number of cables 14 (FIG. 4) which has a dimensionally stable supporting frame 1 on which two feeding wheels 3, a pressure roller 2, an abutment 5 and two roll receptacles 6 which are spaced apart from one another are retained. One adhesive tape roll 7 respectively is affixed onto these roll receptacles 6 in an unrolling manner for the unwinding of an adhesive tape 8.

The feeding wheels 3, shown in FIG. 7, have on their periphery, a number of notches 4 into which, in each case, a cable 14 can be inserted, with the feeding wheels 3 being turned in the direction of the pressure roller 2 through pressure onto the inserted cable(s) 14.

This pressure roller 2 is arranged in a spring-loaded manner in the direction of the abutment 5, which is configured as the roller, with the axis of rotation of the pressure roller 2, like that of the feeding wheels 3 and of the abutment 5, being arranged in one plane in the stroke direction of the pressure roller 2.

The pressure roller 2 is rotatably held in a roller holder 9, which is displaceably affixed to the supporting frame 1 by means of a pressure spring 10 and which has a guide track for the adhesive tapes 8. The pressure spring 10 is supported at one end on the roller holder 9 and at the other end, on the supporting frame 1.

The adhesive tapes 8 of the respective adhesive tape roll 7 are guided such that they run with their adhesive faces facing one another between the abutment 5 and the pressure roller 2, with the cable 14 being adhesively held between the two adhesive tapes 8, while the adjacent regions of the adhesive tapes 8 are also glued together.

To protect the lower adhesive tape 8, a guard 11 is attached to a swivel table 12 which is affixed to the supporting frame 1 and which, as reflected in particular by FIG. 3, is held on a support 13 in a pivotable manner in the axial direction of the feeding wheel 3. Through the pivotability of the swivel table 12, there arises an increased storage possibility for longer cables.

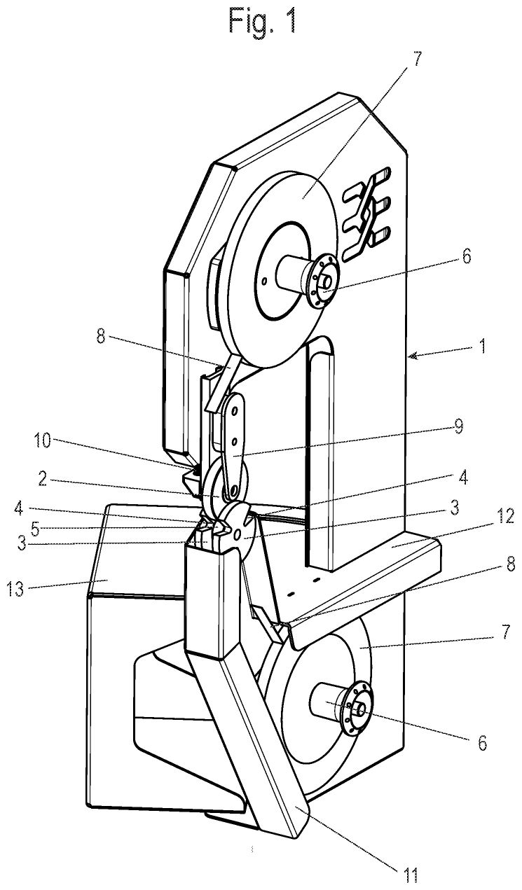

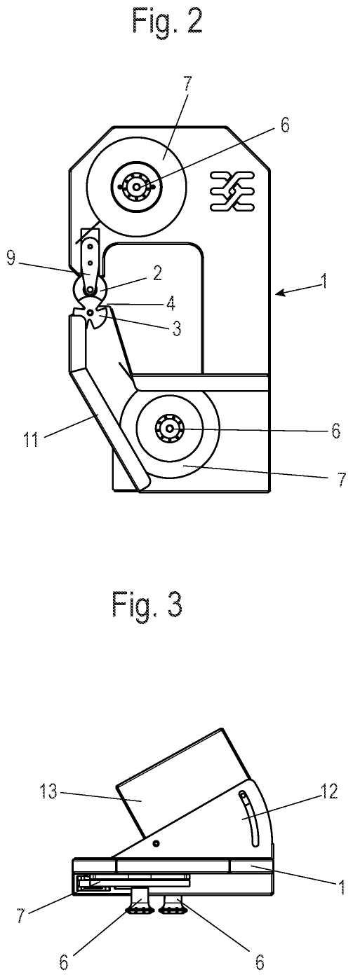

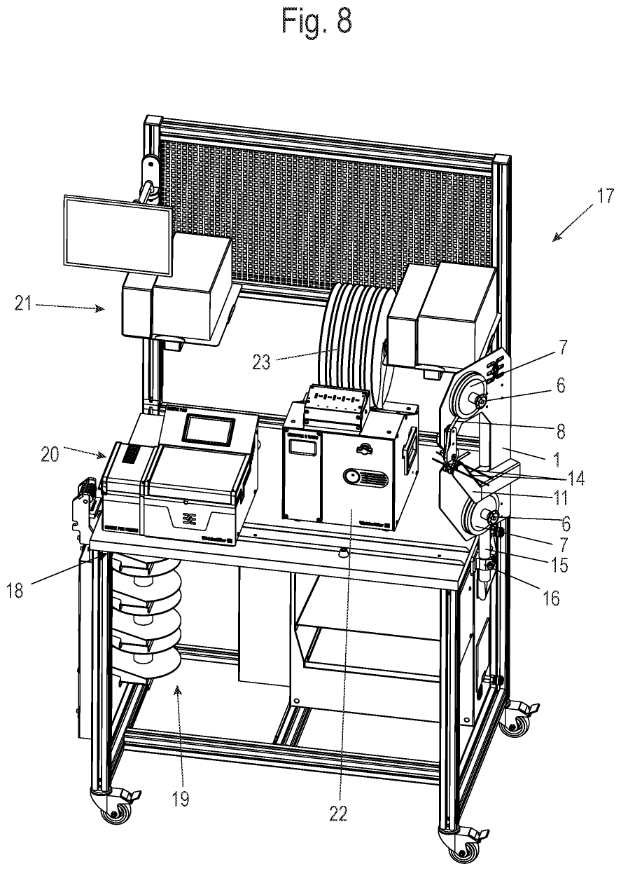

While FIGS. 1-3 depict a device which can be employed in a standalone manner, the example of a device depicted in FIGS. 4a-4d and 8 is configured such that it can be attached to a modular cable-processing center 17, with the device, which is affixed to a mobile frame 18, being depicted in a mounted state in FIG. 8.

The modular cable-processing center 17, in accordance with DE 10 2018 131 439 A1, has a number of cable rollers 19, a trimming machine 20, a marking system 21, a crimping machine 22 and a drum magazine 23.

To affix the device, a rod 15, which is affixed to the frame 18 by means of a pipe clip 16, is connected to the supporting frame 1.

FIGS. 4a-4d in each case depict the device with cables 14 inserted into the feeding wheels 3, and with the feeding wheels 3 in different rotational positions.

FIG. 4a thus shows a situation in which a cable 14 is inserted into a notch 4 before this cable 14, through the turning of the feeding wheel 3, reaches into the operating region of the pressure roller 2 and of the abutment 5, as can be seen in FIG. 4b.

Further, when the initial cable 14 is fixed by the glued-together adhesive tapes 8, a further cable 14, in accordance with the depiction in FIG. 4c, is inserted into the notch 4 which is situated in front in the direction of rotation. FIG. 4d finally shows the situation in which the subsequently guided cable 14 is likewise guided into the operating region of the pressure roller 2 and of the abutment 5.

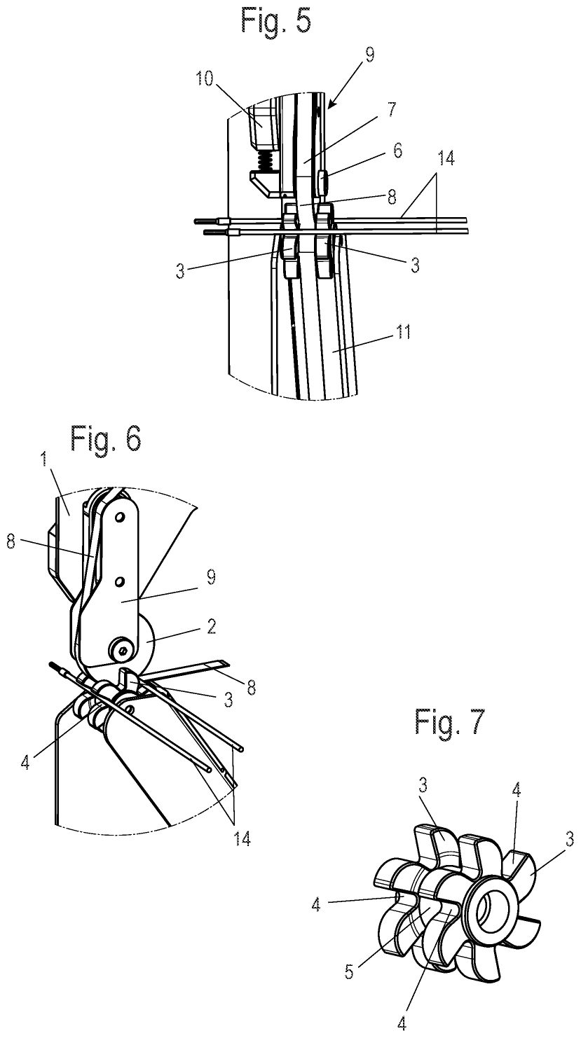

FIG. 5 shows the arrangement of the feeding wheels 3 which are fitted with two cables 14 in their notches. It can be seen that the spacing between the feeding wheels 3 corresponds to the thickness of the abutment 5 arranged between the two feeding wheels 3 and to the maximum width of the adhesive tape 8, which means that the two adhesive tapes 8 which lie against one another lie exactly on one another when they are glued together. Here, the two feeding wheels 3 practically form, with their faces which face one another, a guide for the adhesive tapes 8.

Referring to FIG. 6, the positioning of the two cables 14 is shown. One of the cables is fixed by the glued-together adhesive tapes 8, while the front one is inserted into the notches 4 before it reaches into the operating region of the pressure roller 2 with the abutment 5.

FIG. 7 shows the unit of the feeding wheels 3 and the abutment 5, which form a functional unit in such a way that they rotate identically, with the notches 4 of the feeding wheels 3, which are situated opposite one another, being congruent. The flanks of the notches 4 are formed such that the flank facing away from the direction of rotation is configured to be convex in order to enable easier insertion of the respective cable 14.

What is claimed is:

1. A device for bundling a number of cables, comprising:
at least one rotatable feeding wheel having a plurality of notches arranged on its periphery for receiving at least one cable;
a spring-loaded pressure roller configured for contact with an abutment; and
two spaced-apart roll receptacles each for mounting a roll of unwindable adhesive tape,
wherein adhesive tape from each roll is guided between the abutment and the pressure roller such that an adhesive surface of each adhesive tape faces an adhesive surface of the other.

2. The device according to claim 1, further comprising two spaced-apart feeding wheels rotationally fixed relative to one another and between which the abutment is arranged.

3. The device according to claim 1, wherein the abutment is configured as a roller.

4. The device according to claim 2, wherein the distance between the feeding wheels and thickness of the abutment correspond to a maximum width of the adhesive tape, whereby the adhesive tape can be freely guided between the feeding wheels.

5. The device according to claim 4, wherein respective notches of the feeding wheels are situated opposite one another and congruent.

6. The device according to claim 1, wherein the pressure roller is connected with a roller holder being displaceably connected with the supporting frame in a stroke direction of the pressure roller.

7. The device according to claim 6, and further comprising a pressure spring arranged between the supporting frame and roller holder.

8. The device according to claim 1, wherein the supporting frame includes a swivel table supported pivotably in the axial direction of the feeding wheel on a support and can be locked depending on the pivot position.

9. The device according to claim 1, wherein a roll of adhesive tape can be arranged on a roll receptacle.

10. The arrangement of a device according to claim 1 on a modular cable-processing center having at least one of a plurality of cable rollers, a trimming machine, a marking system, a crimping machine and a drum magazine.
